(19) United States
(12) Patent Application Publication
(10) Pub. No.: US 2019/0025734 A1
(43) Pub. Date: Jan. 24, 2019

(54) ELECTROSTATIC PRINTING METHODS AND SYSTEMS

(71) Applicant: HP Indigo B.V., Amstelveen (NL)

(72) Inventors: Hannoch RON, Nes Ziona (IL); Gieb ROMANTCOV, Nes Ziona (IL); Daniel SKVIRSKY, Nes Ziona (IL); Wael SALALHA, Nes Ziona (IL); Tali AQUA, Nes Ziona (IL)

(73) Assignee: HP Indigo B.V., Amstelveen (NL)

(21) Appl. No.: 16/070,378

(22) PCT Filed: Apr. 20, 2016
(86) PCT No.: PCT/EP2016/058702

§ 371 Date: Jul. 16, 2018

(51) Int. Cl. G03G 15/16; G03G 15/01; G03G 9/087; G03G 9/097

(52) U.S. Cl. CPC G03G 15/161; G03G 9/09775; G03G 9/08726; G03G 15/0131

(57) ABSTRACT

Herein is disclosed a method for electrostatic printing. The method may comprise: a. electrostatically printing a discontinuous layer of a transparent electrostatic ink in a first area on a print substrate; b. electrostatically printing an image comprising a coloured electrostatic ink on the print substrate in a second area, which may or may not be in the same location as the first area, wherein the electrostatic printing in each of steps a and b involves, respectively, transferring the transparent electrostatic ink or the coloured electrostatic ink from a photoimaging plate to the print substrate via an intermediate transfer member. The method may then involve repeating steps a and b on the same or different print substrates, wherein each repeat of step b results in the same or a different printed image, and the discontinuous layer of transparent electrostatic ink varies between at least two different printing patterns. A system is also disclosed herein.

Electrostatic printing processes can involve creating an image on a photoconductive surface, applying an ink having charged particles to the photoconductive surface, such that they selectively bind to the image, and then transferring the charged particles in the form of the image to a print substrate.

The photoconductive surface may be on a cylinder and may be termed a photo imaging plate (PIP). The photoconductive surface is selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, more commonly, by being first transferred to an intermediate transfer member, which can be a soft swelling blanket, and then to the print substrate.

### BRIEF DESCRIPTION OF THE FIGURES

FIG. 1 depicts an example of a print pattern used in Example 1 below, showing image areas of various colours and percentage ink coverages, as well as the surrounding background areas, with the background area on left-hand side of the page being the area protected by the transparent ink.

FIG. 2 depicts examples of three different patterns for the discontinuous layer of transparent electrostatic ink, each providing a predetermined coverage of the area shown (e.g. 20%, 40% or 60%), depending on the thickness of the lines/size of the dots.

FIG. 3 shows a 60% coverage black ink layer printed after 20K copies of the synthetic job depicted in FIG. 1 had been printed. FIG. 3(a) shows the result of no use of protective ink. FIG. 3(b) shows the effect of using HP Indigo Transparent ElectroInk® on the lefthand half of the substrate (at 40% coverage), printed in the alternating pattern shown in FIG. 2. FIG. 3(c) shows the effect of using HP Indigo ElectroInk® Primer on the lefthand half of the substrate (at 40% coverage), printed in the alternating pattern shown in FIG. 2. FIG. 3d is a graph of the difference in the size of the black dots in the ex-image and ex-background areas of a 60% coverage black ink layer printed after 20K copies of the synthetic job depicted in FIG. 1 for different percentage coverages of transparent protective ink.

FIG. 4 shows a grayscale image of a yellow cleaning page printed after 20K copies of the synthetic job depicted in FIG. 1 with an alternating pattern of HP Indigo ElectroInk® Primer providing 40% coverage.

FIG. 5 shows, schematically, an example of a system for electrostatic printing, as described herein.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” or “carrier vehicle” refers to the fluid in which pigment particles, thermoplastic resin, charge directors and other additives can be dispersed to form a liquid electrostatic composition or electrophotographic composition. The carrier liquids may include a mixture of a variety of different agents, such as surfactants, co-solvents, viscosity modifiers, and/or other possible ingredients.

As used herein, “electrostatic ink composition” or “liquid electrophotographic composition” generally refers to an ink composition that is typically suitable for use in an electrostatic printing process, sometimes termed an electrophotographic printing process. It may comprise particles comprising a thermoplastic resin. The transparent and/or coloured electrostatic ink composition may be a liquid electrostatic ink composition, in which the particles comprising a resin are suspended in a carrier liquid. In a coloured electrostatic ink composition, the particles may further include a colourant. In the transparent electrostatic ink composition, the particles may lack or substantially lack a colourant, but may further comprise a solid polar compound as described herein. The particles comprising resin will typically be charged or capable of developing charge in an electric field, such that they display electrophoretic behaviour. A charge director may be present to impart a charge to the pigment particles having resin thereon.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the electrostatic composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @140° C., units are mPa-s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid composition is employed in the electrophotographic process rather than a powder toner. An electrostatic printing process may involve subjecting the electrostatic composition to an electric field, e.g., an electric field having a field gradient of 50-400 V/μm, or more, in some examples 600-900 V/μm, or more.

Examples in the present disclosure can be provided as or use methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices, linked as appropriate to an electrostatic printing device, to realize the method described herein. In particular, a processor or processing apparatus and associated electrostatic printing device may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, and unless stated otherwise, wt % values are to be taken as referring to a weight-for-weight (w/w) percentage of solids in the ink composition, and not including the weight of any carrier fluid present.

Unless otherwise stated, any feature described herein can be combined with any aspect or any other feature described herein.

Herein is disclosed a method for electrostatic printing. The method may comprise:
a. electrostatically printing a discontinuous layer of a transparent electrostatic ink in a first area on a print substrate;
b. electrostatically printing an image comprising a coloured electrostatic ink on the print substrate in a second area, which may or may not be in the same location as the first area,
   wherein the electrostatic printing in each of steps a and b involves, respectively, transferring the transparent electrostatic ink or the coloured electrostatic ink from a photoimaging plate to the print substrate via an intermediate transfer member;
c. repeating steps a and b on the same or different print substrates, wherein each repeat of step b results in the same or a different printed image, and the discontinuous layer of transparent electrostatic ink varies between at least two different printing patterns.

Herein is also disclosed an electrostatic printing system. The system may comprise a photoimaging plate and an intermediate transfer member, and the system may be to carry out a method comprising:
a. electrostatically printing a discontinuous layer of a transparent electrostatic ink in a first area on a print substrate;
b. electrostatically printing an image comprising a coloured electrostatic ink on the print substrate in a second area, which may or may not be in the same location as the first area,
   wherein the electrostatic printing in steps a and b involves, respectively, transferring the transparent electrostatic ink or the coloured ink from the photoimaging plate to the print substrate via the intermediate transfer member;
c. repeating steps a and b on the same or different print substrates, wherein each repeat of step b results in the same or a different printed image, and the discontinuous layer of transparent electrostatic ink varies between at least two different printing patterns.

The lifespan of an intermediate transfer member (sometimes termed a blanket) in an electrostatic printing system in many cases is shortened due to “blanket memories”. Blanket memories develop on an intermediate transfer member over time, for example in printing many thousands of print substrates, when portions of it are used heavily as ‘print areas’ (i.e. the areas used to transfer the ink from the image areas on the photoimaging plate to the print substrate) and other portions are used heavily as ‘background’ areas (i.e. not transferring any ink from the photoimaging plate to the print substrate). This translates into different print behaviour between the two types of areas. This difference in print behaviour can be observed, for example, when a continuous colour is printed on a substrate using both areas, and there is a noticeable difference in the ink transferred in these areas (and hence it appears a ‘memory’ of the background and image areas is retained on the blanket). It has been found that printing a transparent electrostatic ink in a discontinuous manner, together with a coloured ink, can reduce blanket memories and extend the life of the blanket in a cost-effective way. It has been found to particularly effective when the transparent electrostatic ink contains a solid polar compound, as described herein.

Steps a and b

As indicated, the method may comprise:
a. electrostatically printing a discontinuous layer of a transparent electrostatic ink in a first area on a print substrate;
b. electrostatically printing an image comprising a coloured electrostatic ink on the print substrate in a second area, which may or may not be in the same location as the first area.

Steps a and b may be carried out such that step a is first and then step b is second or in the reverse order, such that step b is first and step a is second.

The discontinuous layer may be a layer that contains lines or discrete islands of transparent electrostatic ink. The lines may be straight or curved or wavy. The discrete islands may be in a regular array, e.g. arranged in rows, or an irregular array, e.g. a randomised pattern. The discrete islands may be in the forms of dots of transparent electrostatic ink, and the discrete islands or dots may be of any shape, when viewed from above a print substrate when printed. For example, the may be in a regular shape or an irregular shape. The discrete islands or dots may be in the form of a circle, oval, ovoid, or an n-sided shaped, e.g. an n-sided regular shape, where n is 3 or more, e.g. from 3 to 12.

At least part of the first area may be in the same location as the second area. In some examples, the first area may cover the whole of a print substrate. In some examples, the first area may cover only the part of the print substrate that is not the second area. In some examples, a continuous layer of transparent electrostatic ink composition is printed in the location of at least part or, optionally all of, the second area, and the discontinuous layer of transparent electrostatic ink is printed outside of the second area and, in some examples, the continuous layer of transparent electrostatic ink composition may be printed before or after the coloured electrostatic ink composition is printed.

The discontinuous layer occupies less than 100% of the area of first area, in some examples 80% or less of the area of the first area, in some examples 70% or less of the area of the first area, in some examples 60% or less of the area of the first area, in some examples 50% or less of the area of the first area, in some examples 40% or less of the area of the first area, in some examples 30% or less of the area of the first area, in some examples 20% or less of the area of the first area.

In some examples, the discontinuous layer may occupy 1% to 80% of the area of the first area, in some examples 10% to 50% of the area of the first area, in some examples 10% to 30% of the area of the first area.

As indicated, the electrostatic printing in step a may involve transferring the transparent electrostatic ink from a photoimaging plate to the print substrate via an intermediate transfer member. As indicated, the electrostatic printing in step b may involve transferring the coloured electrostatic ink from a photoimaging plate to the print substrate via an intermediate transfer member. The photoimaging plate may be the same in both steps a and b. The intermediate transfer member is the same in both steps a and b.

The electrostatic printing of the transparent electrostatic ink composition may comprise
forming a latent electrostatic image on a surface of the photoimaging plate;
contacting the surface with the transparent electrostatic ink composition, such that at least some of the transparent electrostatic ink composition adheres to the surface to form a developed transparent toner image on the surface, and transferring the transparent toner image to a target substrate via an intermediate transfer member. The transparent electrostatic ink composition during printing may comprise particles, which may be termed toner particles, the particles comprising the thermoplastic resin, and, in some examples, a solid polar compound and/or a charge adjuvant and/or a charge director.

The electrostatic printing of the coloured electrostatic ink composition may comprise
forming a latent electrostatic image on a surface of the photoimaging plate;
contacting the surface with the coloured electrostatic ink composition, such that at least some of the coloured electrostatic ink composition adheres to the surface to form a developed coloured toner image on the surface, and transferring the coloured toner image to a target substrate via an intermediate transfer member. The coloured electrostatic ink composition during printing may comprise particles, which may be termed toner particles, the particles comprising the thermoplastic resin, and, in some examples, a pigment and/or a charge adjuvant and/or a charge director.

The electrostatic printing of the transparent electrostatic ink and the coloured electrostatic ink may be carried out in a single pass, e.g. by printing the transparent electrostatic ink composition and the coloured electrostatic ink together onto the print substrate. In some examples, this may involve disposing the coloured electrostatic ink first on an intermediate transfer member in an electrostatic printing process and then forming an overlying layer of transparent electrostatic ink composition on and/or around the coloured electrostatic ink, and transferring the coloured electrostatic ink and the layer of transparent electrostatic composition to the print substrate.

In some examples, the electrostatic printing of the transparent electrostatic ink and the coloured electrostatic ink are carried out in separate passes, e.g. by transferring one of the transparent electrostatic ink and the coloured electrostatic ink to the intermediate transfer member and then to the print substrate before the other of the transparent electrostatic ink and the coloured electrostatic ink is transferred to the intermediate transfer member and the print substrate.

The surface of the photoimaging plate on which the latent electrostatic image is formed may be on a rotating member, e.g. in the form of a cylinder.

The intermediate transfer member may be a rotating member, e.g. in the form of a cylinder, which is in some examples heated, e.g. to a temperature of from 80 to 160° C., in some examples from 90 to 130° C., in some examples from 100 to 110° C. The intermediate transfer member may comprise a layer of compressible material thereon.

Repeating Steps a and b

The method may involve repeating steps a and b on the same or different print substrates. In some examples, steps a and b are carried out on a first print substrate, and then steps a and b are repeated on a second print substrate, different from the first print substrate. In some examples, steps a and b may be repeated at least once on the same print substrate, optionally before a further print substrate is printed using steps a and b.

In some examples, each repeat of step b results in the same or a different printed image. In some examples, the same printed image is printed in each repeat of step b on a plurality of print substrates, but, in some examples, the image is in a different location on at least some of the print substrates. The printed image may comprise a plurality of coloured electrostatic inks, e.g. selected from magenta, cyan, yellow, black and white.

In some examples, the discontinuous layer of transparent electrostatic ink varies between at least two different printing patterns. The two different printing patterns may different in the shapes and/or locations of the image printed with the transparent electrostatic ink. In an example, the different printing patterns are the same in the nature of the image printed (e.g. which may be in the form of lines or dots, as indicated above), but different in location of the image on the print substrate (and different print substrates may be used for different printing patterns). For example, if lines are printed in a first step a, then in a second step a, the same lines may be printed (e.g. in terms of thickness), but moved in location on the print substrate, so that they are not in the same position as the lines of the first step a. Similarly, if the printing pattern of the transparent electrostatic ink in first step a is an array of dots, in a second step a, the same array of dots may be printed (in terms of the shape of the dots and their relative locations to one another), but moved in location on the print substrate, so that they are not in the same position as the dots of the first step a. In each of these examples, a different print substrate may be used for the first step a and the second step a, but the print substrates used in the first and second step ‘a's may be of the same shape and size.

In some examples, the two different printing patterns each comprise the same repeating motif, the motifs in each different printing pattern having different locations on the print substrate. The repeating motif may comprise lines or dots, as described herein.

In some examples, over a plurality of repeats of steps a and b, substantially all of the intermediate transfer member that contacts the print substrate has come into contact with the transparent electrostatic ink or the coloured electrostatic ink or both.

In some examples, in repeating step b, the same image of coloured electrostatic ink is printed, and the area on the print substrate on which the coloured electrostatic ink is printed is termed an image area and the remaining area of the print substrate is termed a background area, and the discontinuous layer of transparent electrostatic ink is printed on the substrate in at least part of, optionally all of, the background area.

The electrostatic printing may be carried out so that a plurality of print substrates are printed. The number of print substrates printed may be at least 10, in some examples at least 100, in some examples at least 1000, in some examples at least 5000.

Transparent Electrostatic Ink

The transparent electrostatic ink, which may also be termed a transparent electrostatic ink composition, may comprise a thermoplastic resin. It may further comprise a charge adjuvant and/or a charge director. The transparent electrostatic ink composition does not contain any pigment, or substantially lacks pigment and thus is a pigment-free composition. The transparent electrostatic ink composition may otherwise be termed a colourless electrostatic ink composition or a colorless varnish for digital printing. The transparent electrostatic ink composition may comprise less than 5 wt % solids of colorant, in some examples less than 3 wt % solids of colorant, in some examples less than 1 wt % solids of colorant. “Colorant” may be a material that imparts a color to the ink composition. As used herein, “colorant” includes pigments and dyes, such as those that impart colors such as black, magenta, cyan, yellow and white to an ink. As used herein, “pigment” generally includes pigment colorants, magnetic particles, aluminas, silicas, and/or other ceramics or organo-metallics. Thus, though the present description primarily exemplifies the use of pigment colorants, the term “pigment” can be used more generally to describe not only pigment colorants, but other pigments such as organometallics, ferrites, ceramics, etc.

The thermoplastic resin may constitute at least 85 wt % of the solids of the transparent electrostatic ink composition, in some examples at least 90 wt % solids of the solids of the transparent electrostatic ink composition, in some examples 95, wt % of the solids of the transparent electrostatic ink composition.

If a solid polar compound is present, the thermoplastic resin and the solid polar compound together may constitute at least 85 wt % of the solids of the transparent electrostatic ink composition, in some examples at least 90 wt % of the solids of the transparent electrostatic ink composition, in some examples 95, wt % of the solids of the transparent electrostatic ink composition.

The transparent electrostatic ink composition may further comprise at least one additive such as surfactants, viscosity modifiers, emulsifiers and the like.

In some examples, once printed, the transparent electrostatic ink composition forms a discontinuous layer of less than 10 μm in thickness, for example less than 9 μm in thickness, less than 8 μm in thickness, less than 7 μm in thickness, less than 6 μm in thickness, less than 5 μm in thickness, less than 4 μm in thickness, less than 3 μm in thickness, less than 2 μm in thickness, less than 1.5 μm in thickness. In some examples, the transparent electrostatic ink composition is about 1 μm in thickness.

In some examples, once printed, the transparent electrostatic ink composition forms a discontinuous layer greater than 0.1 μm in thickness, for example greater than 0.2 μm in thickness, greater than 0.3 μm in thickness, greater than 0.4 μm in thickness, greater than 0.5 μm in thickness, greater than 0.6 μm in thickness, greater than 0.7 μm in thickness, greater than 0.8 μm in thickness, greater than 0.9 μm in thickness. In some examples, the film of material is about 1 μm in thickness.

Coloured Electrostatic Ink

The coloured electrostatic ink, which may also be termed a coloured electrostatic ink composition, may comprise a colourant. The colourant may be selected from magenta, cyan, yellow, black and white. The coloured electrostatic ink may comprise at least 5 wt % solids of colorant, in some examples at least 8 wt % solids of colourant, in some examples at least 10 wt % solids of colourant, in some examples at least 15 wt % solids of colourant. The coloured electrostatic ink, which may also be termed a coloured electrostatic ink composition, may comprises a thermoplastic resin, which may be the same as or different from any thermoplastic resin that the transparent electrostatic ink contains.

The coloured electrostatic ink may substantially lack (e.g. contain less than 1 wt % solids) or lack a solid polar compound as described herein.

Liquid Carrier

In some examples, when printing, the transparent electrostatic ink composition and/or the coloured electrostatic ink composition comprises a liquid carrier. The liquid carrier for the transparent electrostatic ink composition and the liquid carrier for the coloured electrostatic ink composition may be the same as one another or different from one another. Generally, the liquid carrier can act as a dispersing medium for the other components in the electrostatic ink composition. For example, the liquid carrier can comprise or be a hydrocarbon, silicone oil, vegetable oil, etc. The liquid carrier can include, but is not limited to, an insulating, non-polar, non-aqueous liquid that can be used as a medium for toner particles. The liquid carrier can include compounds that have a resistivity in excess of about 10⁹ ohm-cm. The liquid carrier may have a dielectric constant below about 5, in some examples below about 3. The liquid carrier can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the liquid carriers include, but are not limited to, aliphatic hydrocarbons, isoparaffinic compounds, paraffinic compounds, dearomatized hydrocarbon compounds, and the like. In particular, the liquid carriers can include, but are not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™)

Before electrostatic printing, the liquid carrier can constitute about 20% to 99.5% by weight of the transparent and/or coloured electrostatic ink composition, in some examples 50% to 99.5% by weight of the transparent and/or coloured electrostatic ink composition. Before printing, the liquid carrier may constitute about 40 to 90% by weight of the transparent and/or coloured electrostatic ink composition. Before printing, the liquid carrier may constitute about 60% to 80% by weight of the transparent and/or coloured electrostatic ink composition. Before printing, the liquid carrier may constitute about 90% to 99.5% by weight of the transparent and/or coloured electrostatic ink composition, in some examples 95% to 99% by weight of the transparent and/or coloured electrostatic ink composition.

The transparent or coloured electrostatic ink, when electrostatically printed on the print substrate, may be substantially free from liquid carrier. In an electrostatic printing process and/or afterwards, the liquid carrier may be removed, e.g. by an electrophoresis processes during printing and/or evaporation, such that substantially just solids are transferred to the print substrate. Substantially free from liquid carrier may indicate that the ink printed on the print substrate contains less than 5 wt % liquid carrier, in some examples, less than 2 wt % liquid carrier, in some examples less than 1 wt % liquid carrier, in some examples less than 0.5 wt % liquid carrier. In some examples, the ink printed on the print substrate is free from liquid carrier.

Thermoplastic Resin

The transparent and/or coloured electrostatic ink composition may include a thermoplastic resin, referred to as the resin. A thermoplastic polymer is sometimes referred to as a thermoplastic resin. The resin for the transparent electrostatic ink composition and the resin for the coloured electrostatic ink composition may be the same as one another or different from one another.

The resin typically includes a polymer. The resin can include, but is not limited to, a thermoplastic polymer. In some examples, the polymer of the resin may be selected from ethylene acrylic acid copolymers; ethylene methacrylic acid copolymers; ethylene vinyl acetate copolymers; copolymers of ethylene (e.g. 80 wt % to 99.9 wt %), and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with at least one counterion, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt % to about 25 wt % of the copolymer, in some examples from 10 wt % to about 20 wt % of the copolymer.

The resin may comprise two different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise two different polymers having acidic side groups: a first polymer that is a copolymer of ethylene (e.g. 92 to 85 wt %, in some examples about 89 wt %) and acrylic or methacrylic acid (e.g. 8 to 15 wt %, in some examples about 11 wt %) having a melt flow rate of 80 to 110 g/10 minutes and a second polymer that is a co-polymer of ethylene (e.g. about 80 to 92 wt %, in some examples about 85 wt %) and acrylic acid (e.g. about 18 to 12 wt %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt % to about 16 wt % of the copolymer, in some examples 10 wt % to 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt % to about 30 wt % of the copolymer, in some examples from 14 wt % to about 20 wt % of the copolymer, in some examples from 16 wt % to about 20 wt % of the copolymer in some examples from 17 wt % to 19 wt % of the copolymer.

In an example, the thermoplastic resin constitutes about 10 to 99%, in some examples about 15 to 95%, by weight of the solids of the transparent and/or coloured electrostatic ink composition. In another example, the resin constitutes about 20 to 95% by weight of the solids of the transparent and/or coloured electrostatic ink composition. In another example, the resin constitutes about 25 to 95% by weight of the solids of the transparent and/or coloured electrostatic ink composition. In another example, the resin constitutes about 35 to 95% by weight, in some examples from 75 to 95% by weight, of the solids of the transparent and/or coloured electrostatic ink composition. In another example, the resin constitutes about 35 to 95% by weight, in some examples from 75 to 99% by weight, of the solids of the transparent and/or coloured electrostatic ink composition.

The thermoplastic resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the co-polymer, in some examples 5 to 40% by weight, in some examples 5 to 20% by weight of the copolymer, in some examples 5 to 15% by weight of the copolymer. The second monomer may constitute 1 to 50% by weight of the co-polymer, in some examples 5 to 40% by weight of the co-polymer, in some examples 5 to 20% by weight of the co-polymer, in some examples 5 to 15% by weight of the copolymer. In an example, the first monomer constitutes 5 to 40% by weight of the co-polymer, the second monomer constitutes 5 to 40% by weight of the co-polymer, and with the third monomer constituting the remaining weight of the copolymer. In an example, the first monomer constitutes 5 to 15% by weight of the co-polymer, the second monomer constitutes 5 to 15% by weight of the co-polymer, with the third monomer constituting the remaining weight of the copolymer. In an example, the first monomer constitutes 8 to 12% by weight of the co-polymer, the second monomer constitutes 8 to 12% by weight of the co-polymer, with the third monomer constituting the remaining weight of the copolymer. In an example, the first monomer constitutes about 10% by weight of the co-polymer, the second monomer constitutes about 10% by weight of the co-polymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

Charge Director and Charge Adjuvant

In some examples, the transparent and/or coloured electrostatic ink composition includes either a charge director or a charge adjuvant or both.

The charge director may be added in order to impart and/or maintain sufficient electrostatic charge on ink particles during electrostatic printing, which may be particles comprising the thermoplastic resin (and, for the transparent electrostatic ink, the solid polar compound, if present, as mentioned herein). The charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of an electrostatic ink composition.

In some examples, the transparent and/or coloured electrostatic ink composition comprises a charge director comprising a simple salt. Simple salts are salts that do not form micelles by themselves, although they may form a core for micelles with a micelle forming salt. The ions constructing the simple salts are all hydrophilic. The simple salt may include a cation selected from the group consisting of Mg, Ca, Ba, NH4, tert-butyl ammonium, Li+, and Al+3, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F—, ClO₄—, and TiO₃⁴⁻, or from any sub-group thereof. The simple salt may be selected from CaCO_{3,} Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof.

The charge director may include at least one of (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In some examples, the transparent and/or coloured electrostatic ink composition comprises a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²]⁻ (I)

wherein each of R¹ and R² is an alkyl group.

The sulfosuccinate salt of the general formula MAn is an example of a micelle forming salt. The charge director may be substantially free or free of an acid of the general formula HA, where A is as described above. The charge director may include micelles of said sulfosuccinate salt enclosing at least some of the nanoparticles. The charge director may include at least some nanoparticles having a size of 200 nm or less, and/or in some examples 2 nm or more.

In the formula [R₁—O—C(O)CH₂CH(SO₃⁻)C(O)—O—R₂], in some examples each of R₁ and R₂ is an aliphatic alkyl group. In some examples, each of R₁ and R₂ independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇. In some examples, M is Na, K, Cs, Ca, or Ba.

In some examples, the charge director constitutes about 0.001% to 20%, in some examples 0.01% to 20% by weight, in some examples 0.01 to 10% by weight, in some examples 0.01% to 1% by weight of the solids of the transparent and/or coloured electrostatic ink composition. In some examples, the charge director constitutes about 0.001% to 0.15% by weight of the solids of the transparent and/or coloured electrostatic ink composition, in some examples 0.001% to 0.15%, in some examples 0.001% to 0.02% by weight of the solids of the transparent and/or coloured electrostatic ink composition, in some examples 0.1% to 2% by weight of the solids of the transparent and/or coloured electrostatic ink composition, in some examples 0.2% to 1.5% by weight of the solids of the transparent and/or coloured electrostatic ink composition in some examples 0.1% to 1% by weight of the solids of the transparent and/or coloured electrostatic ink composition, in some examples 0.2% to 0.8% by weight of the solids of the transparent and/or coloured electrostatic ink composition. In some examples, the charge director is present in an amount of at least 1 mg of charge director per gram of solids of the transparent and/or coloured electrostatic ink composition (which will be abbreviated to mg/g), in some examples at least 2 mg/g, in some examples at least 3 mg/g, in some examples at least 4 mg/g, in some examples at least 5 mg/g. In some examples, the charge director is present in the amounts stated above, and the charge director is present in an amount of from 1 mg to 50 mg of charge director per gram of solids of the transparent and/or coloured electrostatic ink composition (which will be abbreviated to mg/g), in some examples from 1 mg/g to 25 mg/g, in some examples from 1 mg/g to 20 mg/g, in some examples from 1 mg/g to 15 mg/g, in some examples from 1 mg/g to 10 mg/g, in some examples from 3 mg/g to 20 mg/g, in some examples from 3 mg/g to 15 mg/g, in some examples from 5 mg/g to 10 mg/g.

A charge adjuvant may promote charging of the particles when a charge director is present in the transparent and/or coloured electrostatic ink composition during printing. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co- methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminum di- or tristearate. The charge adjuvant may be present in an amount of about 0.1 to 5% by weight, in some examples about 0.1 to 1% by weight, in some examples about 0.3 to 0.8% by weight of the solids of the transparent and/or coloured electrostatic ink composition, in some examples about 1 wt % to 3 wt % of the solids of the transparent and/or coloured electrostatic ink composition, in some examples about 1.5 wt % to 2.5 wt % of the solids of the transparent and/or coloured electrostatic ink composition.

In some examples, the transparent and/or coloured electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al3+. The fatty acid anion may be selected from a saturated or unsaturated fatty acid anion. The fatty acid anion may be selected from a C₈ to C₂₆ fatty acid anion, in some examples a C₁₄ to C₂₂ fatty acid anion, in some examples a C₁₆ to C₂₀ fatty acid anion, in some examples a C₁₇, C₁₈ or C₁₉ fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of multivalent cation and a fatty acid anion, may be present in an amount of 0.1 wt % to 5 wt % of the solids of the transparent and/or coloured electrostatic ink composition, in some examples in an amount of 0.1 wt % to 2 wt % of the solids of the transparent and/or coloured electrostatic ink composition, in some examples in an amount of 0.1 wt % to 2 wt % of the solids of the transparent and/or coloured electrostatic ink composition, in some examples in an amount of 0.3 wt % to 1.5 wt % of the solids of the transparent and/or coloured electrostatic ink composition, in some examples about 0.5 wt % to 1.2 wt % of the solids of the transparent and/or coloured electrostatic ink composition, in some examples about 0.8 wt % to 1 wt % of the solids of the transparent and/or coloured electrostatic ink composition, in some examples about 1 wt % to 3 wt % of the solids of the transparent and/or coloured electrostatic ink composition, in some examples about 1.5 wt % to 2.5 wt % of the solids of the transparent and/or coloured electrostatic ink composition.

Solid Polar Compound

The transparent electrostatic ink composition may comprise a solid polar compound. In some examples, the solid polar compound is a solid (e.g., at room temperature, i.e., from about 20° C. to about 25° C.), organic material. The solid polar compound may be of low tinctorial strength (e.g. lower in tinctorial strength than any pigment or dye used in the coloured electrostatic ink composition). Once printed in the transparent electrostatic ink composition, the solid polar compound typically imparts little, if any, colour to it. The solid organic material may be a polymeric material or a non-polymeric material. The solid polar compound may be an organic particle that is resistant to swelling or dissolving in a non-polar carrier fluid, e.g. an isoparaffinic fluid as described herein. The solid polar compound may be dispersed in the resin, and, in some examples, is present in an amount up to 60 wt. % of solids in the transparent electrostatic ink composition, in some examples from 10 wt % to 60 wt % of solids in the transparent electrostatic ink composition. The solid polar compound may be selected from the group consisting of a saccharide, polyacrylic acid, polyvinyl alcohol, styrene maleic anhydride, a bismaleimide oligomer, a cellulose derivative and an aliphatic urethane acrylate.

In some examples, the transparent electrostatic ink composition comprises a saccharide or a modified saccharide. In some examples, modified saccharides are acetylated saccharides. In some examples, the transparent electrostatic ink composition comprises a disaccharide or a modified disaccharide. In some examples, the transparent electrostatic ink composition comprises a saccharide or modified saccharide selected from maltose monohydrate, sucrose, sucrose octanoate, sucrose octaacetate, dextrin, xylitol and sucrose benzoate.

In some examples, the transparent electrostatic ink composition comprises the solid polar compound, e.g. a saccharide or a modified saccharide, in an amount of greater than 15 wt % of the non-volatile solids in the electrostatic ink composition, for example, in an amount of greater than 20 wt % of the non-volatile solids in the transparent electrostatic ink composition, for example in an amount of greater than 25 wt % of the non-volatile solids in the transparent electrostatic ink composition, for example in an amount of greater than 30 wt % of the non-volatile solids in the transparent electrostatic ink composition. In some examples, the transparent electrostatic ink composition comprises the solid polar compound, e.g. a saccharide or a modified saccharide, in an amount of less than 60 wt % of the non-volatile solids in the transparent electrostatic ink composition, for example less than 50 wt % of the non-volatile solids in the electrostatic ink composition, for example less than 45 wt % of the non-volatile solids in the transparent electrostatic ink composition, for example less than 40 wt % of the non-volatile solids in the transparent electrostatic ink composition.

In some examples, the saccharide is selected from the group consisting of maltose monohydrate, sucrose, sucrose octanoate, dextrin, xylitol, sucrose octaacetate, and sucrose benzoate. In some examples, the solid polar compound has a particle size from about 30 nm to about 300 nm.

Examples of commercially available styrene maleic anhydrides include copolymers from Sartomer Co. USA, LLC, such as SMA® 4000I, SMA® 1000I, and SMA® 1000P. Examples of cellulose derivatives include sodium carboxylmethyl cellulose and cellulose acetate propionate. A suitable example of a bismaleimide oligomer is bis-stearamide, and a suitable example of an aliphatic urethane acrylate is REAFREE® UV ND-2335 from Arkema, Spain. It is to be understood that these solid polar compounds are examples, and that any other organic material that includes polar atoms and is resistant to swelling or dissolving in a non-polar carrier fluid may be used.

Other Additives

The transparent and/or coloured electrostatic ink composition may include an additive or a plurality of additives. The additive or plurality of additives may be added at any stage of the method. The additive or plurality of additives may be selected from a wax, a surfactant, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket.

As mentioned, also disclosed herein an electrostatic printing system. The system may comprise a photoimaging plate and an intermediate transfer member. The system may be to carry out a method comprising:
a. electrostatically printing a discontinuous layer of a transparent electrostatic ink in a first area on a print substrate;
b. electrostatically printing an image comprising a coloured electrostatic ink on the print substrate in a second area, which may or may not be in the same location as the first area,
   wherein the electrostatic printing in steps a and b involves, respectively, transferring the transparent electrostatic ink or the coloured ink from the photoimaging plate to the print substrate via the intermediate transfer member;
c. repeating steps a and b on the same or different print substrates, wherein each repeat of step b results in the same or a different printed image, and the discontinuous layer of transparent electrostatic ink varies between at least two different printing patterns.

The system may be programmed to carry out steps a, b and c. The system may include a computer readable medium loaded with instructions for carrying out steps a, b and c. The system may be programmed to carry out any features of the steps described herein. For example, the system may programmed such that the two different printing patterns are different in the shapes and/or locations of the image printed with the transparent electrostatic ink. In some examples, the system is programmed such that over a plurality of repeats of steps a and b, substantially all of the intermediate transfer member that contacts the print substrate has come into contact with either the transparent electrostatic ink or the coloured electrostatic ink.

Print Substrate

The print substrate may be or comprise any suitable substrate. The print substrate may be any suitable substrate capable of having an image printed thereon. The print substrate may comprise a material selected from an organic or inorganic material. The material may comprise a natural polymeric material, e.g. cellulose. The material may comprise a synthetic polymeric material, e.g. a polymer formed from alkylene monomers, including, but not limited to, polyethylene and polypropylene, and copolymers such as styrene-polybutadiene. The polypropylene may be biaxially orientated polypropylene. The material may comprise a metal, which may be in sheet form. The metal may be selected from or made from, for instance, aluminum (Al), silver (Ag), tin (Sn), copper (Cu), mixtures thereof. In some examples, the print substrate comprises a cellulosic paper. In some examples, the cellulosic paper is coated with a polymeric material, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The print substrate may be a cellulosic print substrate such as paper. The cellulosic print substrate may be a coated cellulosic print substrate, e.g. having a coating of a polymeric material thereon.

Liquid Electrophotographic (LEP) Printing Apparatus

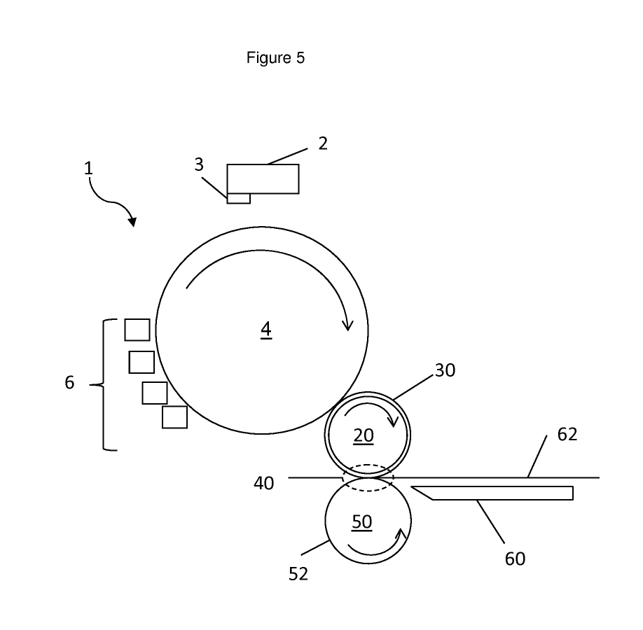

FIG. 5 shows a schematic illustration of an example of an LEP printing system 1 that includes an intermediate transfer member. An image, including any combination of graphics, text and images, is communicated to the LEP printing apparatus 1. The LEP printing apparatus includes a photo charging unit 2 and a photo-imaging cylinder 4. The image is initially formed on a photoimaging plate (also known as a photoconductive member), in this case in the form of a photo-imaging cylinder 4, before being transferred to an outer release layer 30 of the intermediate transfer member (ITM) 20 which is in the form of a roller (first transfer), and then from the outer release layer 30 of the ITM 20 to a print substrate 62 (second transfer).

According to an illustrative example, the initial image is formed on a rotating photo-imaging cylinder 4 by the photo charging unit 2. Firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. Liquid electrophotographic ink is then transferred to the photo-imaging cylinder 4 by binary ink developer (BID) units 6. The BID units 6 present a uniform film of liquid electrophotographic ink (which may be the transparent or the coloured electrostatic ink) to the photo-imaging cylinder 4. The liquid electrophotographic ink contains electrically charged particles which, by virtue of an appropriate potential on the electrostatic image areas, are attracted to the latent electrostatic image on the photo-imaging cylinder 4. The liquid electrophotographic ink does not adhere to the uncharged, non-image areas and forms a developed toner image on the surface of the latent electrostatic image. The photo-imaging cylinder 4 then has a single transparent or colour ink image on its surface (depending on whether a transparent or coloured electrostatic ink has been used).

The developed toner image is then transferred from the photo-imaging cylinder 4 to the outer release layer 30 of the ITM 20 by electrical forces. The image is then dried and fused on the outer release layer 30 of the ITM 20 before being transferred from the outer release layer 30 of the ITM 20 to a print substrate disposed on impression cylinder 50. The process may then be repeated for each of the transparent and/or coloured ink layers to be included on the print substrate (e.g. in steps a and b mentioned herein).

The image is transferred from the photo-imaging cylinder 4 to the ITM 20 by virtue of an appropriate potential applied between the photo-imaging cylinder 4 and the ITM 20, such that the charged ink is attracted to the ITM 20.

Between the first and second transfers, the solid content of the developed toner image is increased and the ink is fused on to the ITM 20. For example, the solid content of the developed toner image deposited on the outer release layer 30 after the first transfer is typically around 20%, by the second transfer the solid content of the developed toner image is typically around 80-90%. This drying and fusing is typically achieved by using elevated temperatures and, in some examples, airflow-assisted drying. In some examples, the ITM 20 is heatable.

The print substrate 62 is fed into the printing apparatus by the print substrate feed tray 60 and is disposed on the impression cylinder 50. As the print substrate 62 contacts the ITM 20, the single colour image is transferred to the print substrate 62.

To form a single colour image (such as a black and white image), one pass of the print substrate 62 through the impression cylinder 50 and the ITM 20 completes the image. For a multiple colour image, the print substrate 62 is retained on the impression cylinder 50 and makes multiple contacts with the ITM 20 as it passes through the nip 40. At each contact an additional colour plane may be placed on the print substrate 62.

### EXAMPLES

The following illustrates examples of the method and related aspects described herein. Thus, these examples should not be considered to restrict the present disclosure, but are merely in place to teach how to make examples of compositions for use in examples of methods of the present disclosure.

### Example 1

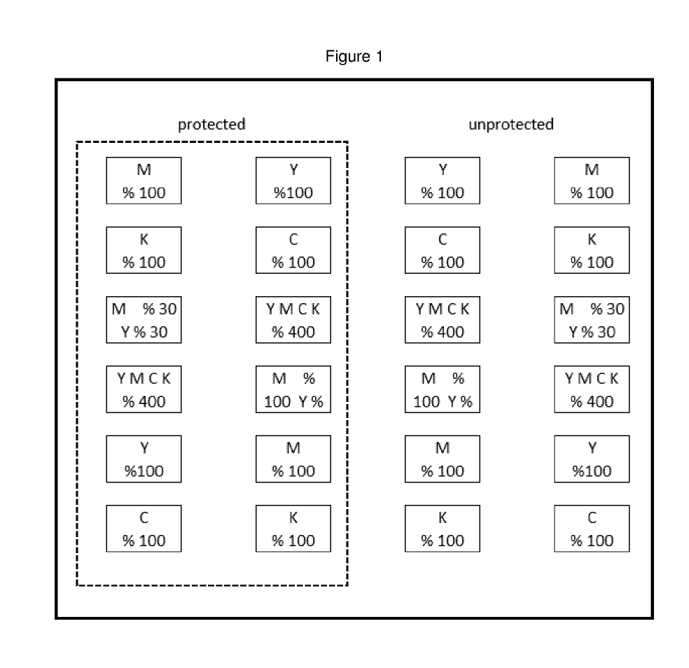

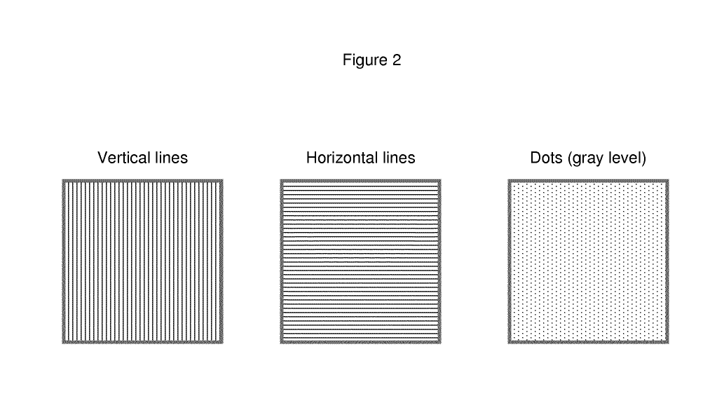

The synthetic job (that is, the print pattern, as shown in FIG. 1) and the protective transparent ink were printed onto paper, namely, Condat 115 g substrate, by using an HP Indigo web press from the 6000 series. The image areas were printed using HP Indigo ElectroInk® 4.5 YMCK inks, i.e. yellow, magenta, cyan and black inks (the image areas in FIG. 1 are the boxes containing the letters ‘Y’, ‘M’, ‘C’ and ‘K’ in the Figure; the background area is the area surrounding the image areas, i.e. the areas in which no cyan, magenta, yellow or black ink was printed). On one half of each substrate (left in FIG. 1), a fifth, transparent, ink was printed in an alternating pattern (such as that shown in FIG. 2) prior to the YMCK, coloured, inks being printed on the substrate. No transparent ink was used on the other half of each substrate (right in FIG. 1). Separate trials were performed for two different transparent inks, HP Indigo ElectroInk® Transparent Ink and HP Indigo ElectroInk® Primer.

HP Indigo ElectroInk® Primer May be Made as Follows.

In the following examples, the resin used is Nucrel 699, available from DuPont, and A-C 5120, available from Honeywell, in a weight ratio of 4:1.

In the following examples, NCD indicates a natural charge director made of three components: KT (natural soya lecithin in phospholipids and fatty acids), BBP (basic barium petronate i.e. a barium sulfonate salt of a 21-26 hydrocarbon alkyl, supplied by Chemtura), and GT (dodecyl benzene sulfonic acid isopropyl amine, supplied by Croda). The composition being 6.6 wt % KT, 9.8 wt % BBP and 3.6 wt % GT, balance 80% Isopar.

In the following examples, SCD indicates a synthetic charge director, being a barium bis sulfosuccinate salt as described in US 2009/0311614 or WO2007130069. This is a strong negative charge director with strong base in the micelle core (barium phosphate) which enhances stable negative charge on ink particle. SCD is a charge director and in the absence of a dispersant) has been found to display very low low field charging (high charge partitioning).

The transparent electrostatic ink for forming the HP Indigo ElectroInk® Primer comprised 1076.4 g paste (an isoparaffinic non-polar carrier fluid with ethylene methacrylic acid copolymers and ethylene acrylic acid co-polymers dispersed therein, namely Nucrel 699 (DuPont) and A-C 5120 (Honeywell) in the ratio of 4:1 (wt:wt)). The paste contained 25 wt % resin solids (i.e. the combination of Nucrel 699 (DuPont) and A-C 5120 (Honeywell)), 184 gr of 100% solid (40 wt %) of maltosemonohydrate (Fisher) and 6.9 gr (1.5 wt %) 100% solid aluminum stearate (grinding aid material/charge adjuvant, available from Sigma Aldrich). 1032.7 gr of Isopar L were added to the attritor. The ink was ground using an attritor (S1 from union process USA) at 30° C. for 24 hours. The ink was diluted to 2 wt % solids in Isopar, charged by adding 8 ml of commercially available HP Indigo Imaging Agent (for use with HP Indigo 6000 series presses; Imaging Agent contains NCD, but SCD could be used) and left over-night prior to printing. Several identical batches were prepared for this work

HP Indigo ElectroInk® Transparent Ink is similar to HP Indigo ElectroInk® Primer, except that it does not contain the maltosemonohydrate.

A new blanket was used in each trial.

An alternating pattern of transparent ink was used to provide 20%, 40% or 60% coverage of the printed area. For 20% coverage, the alternating pattern means that the entire print area is covered with the transparent ink on average once every 5 copies of the synthetic job.

The blanket was “aged” by printing 20K (i.e. 20,000) copies of the synthetic job (FIG. 1). The effect of the protective ink on the blanket was evaluated by printing monitor jobs (a new print pattern used to evaluate the effect of printing 20K copies had on the blanket). Prior to printing the monitor jobs, the blanket was cleaned by printing 4 separations of 100% solid yellow ink. The following monitor jobs were printed:

Monitor Job 1: Black Ink, 60% Coverage

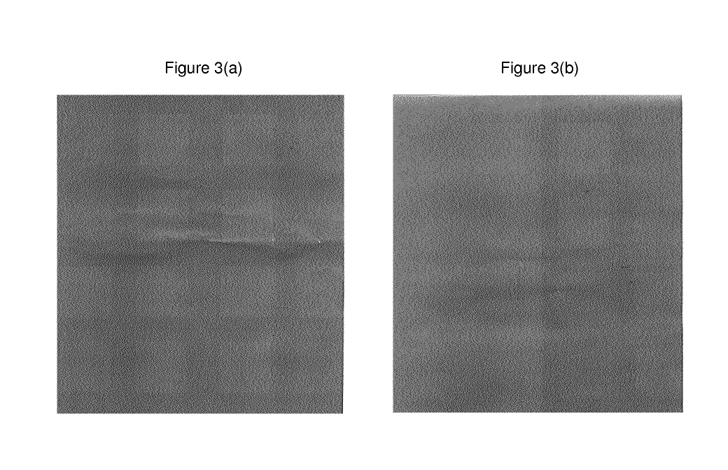

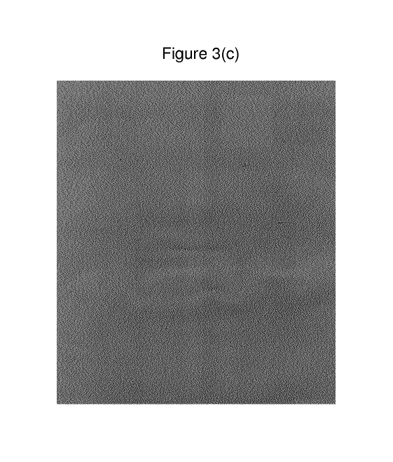

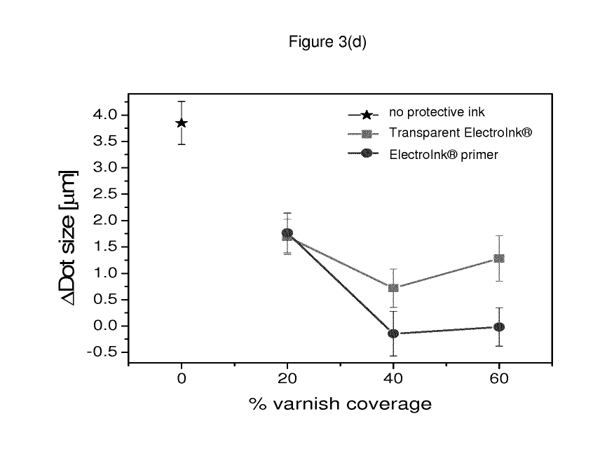

After printing 20K copies of the synthetic job interspersed, on the lefthand side, with the alternating pattern of protective ink shown in FIG. 2, a layer of black ink was printed at 60% coverage over the entire print area (FIG. 3a-c). FIG. 3a shows the effect of no protective ink being used. FIG. 3b shows the effect of a 40% coverage of an alternating pattern of HP Indigo transparent ElectroInk being used on the lefthand side of the substrate (no protective ink was used on the righthand side). FIG. 3c shows the effect of a 40% coverage of an alternating pattern of the HP Indigo ElectroInk Primer being used on the lefthand side of the substrate (no protective ink was used on the righthand side).

In FIG. 3a, the ex-image (areas on which a coloured ink was printed in each copy of the synthetic job) and ex-background (areas on which no coloured ink was printed in the synthetic job) areas are clearly distinguishable from each other despite the uniform application of black ink in a 60% coverage layer across all areas of the substrate. The lefthand sides (with the alternating pattern of the transparent protective ink) of both FIGS. 3b and 3c show a marked improvement in the uniformity of the appearance of the 60% coverage black layer in comparison with the righthand sides on which no protective ink was used.

The 60% coverage black ink screens (FIG. 3a-c) were scanned using a i1iSis 2 Spectrophotometer from X-Rite. The data from the was processed as dedicated by the software to determine the average spot size of the ex-image and ex-background areas. A graph showing the results is provided in FIG. 3d, showing the difference between the spot sizes of the ex-background and ex-image areas for the different percentage coverages of the transparent ink used.

Monitor Job 2—Yellow Ink, 100% Coverage

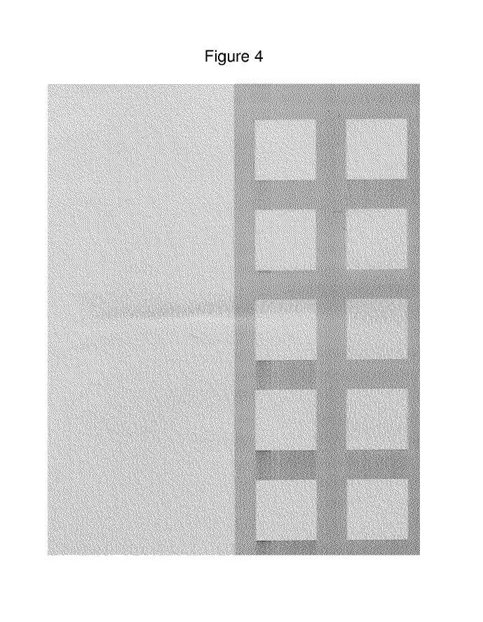

Two separations of solid yellow ink in 100% coverage were printed after running 20K prints of the synthetic job. FIG. 4 shows the results of this in grayscale for the synthetic job in which the alternating pattern resulted in 40% coverage with the HP

Indigo ElectroInk® Primer. The prevention of accumulation of ink on the blanket after 20K prints is demonstrated in the lefthand side of the blanket, whilst the righthand side shows the damage to the blanket when no protective ink was used.

While the method and system has been described with reference to certain examples, those skilled in the art will appreciate that various modifications, changes, omissions, and substitutions can be made without departing from the spirit of the disclosure. It is intended, therefore, that the invention be limited by the scope of the following claims. The feature(s) of any dependent claim can be combined with the feature(s) of any of the other dependent claims and any of the independent claims.

1. A method for electrostatic printing, the method comprising:
a. electrostatically printing a discontinuous layer of a transparent electrostatic ink in a first area on a print substrate;
b. electrostatically printing an image comprising a coloured electrostatic ink on the print substrate in a second area, which may or may not be in the same location as the first area,
wherein the electrostatic printing in each of steps a and b involves, respectively, transferring the transparent electrostatic ink or the coloured electrostatic ink from a photoimaging plate to the print substrate via an intermediate transfer member;
c. repeating steps a and b on the same or different print substrates, wherein each repeat of step b results in the same or a different printed image, and the discontinuous layer of transparent electrostatic ink varies between at least two different printing patterns.

2. The method according to claim 1, wherein the two different printing patterns are different in the shapes and/or locations of the image printed with the transparent electrostatic ink.

3. The method according to claim 1, wherein the two different printing patterns each comprise the same repeating motif, the motifs in each different printing pattern having different locations on the print substrate.

4. The method according to claim 3, wherein the motifs are selected from lines and dots.

5. The method according to claim 1, wherein, over a plurality of repeats of steps a and b, substantially all of the intermediate transfer member that contacts the print substrate has come into contact with one of or both of the transparent electrostatic ink and the coloured electrostatic ink.

6. The method according to claim 1, wherein in repeating step b, the same image of coloured electrostatic ink is printed, and the area on the print substrate on which the coloured electrostatic ink is printed is termed an image area and the remaining area of the print substrate is termed a background area, and the discontinuous layer of transparent electrostatic ink is printed on the substrate in at least part of the background area.

7. The method according to claim 1, where the transparent electrostatic ink comprises a solid polar compound selected from the group consisting of a saccharide, polyacrylic acid, polyvinyl alcohol, styrene maleic anhydride, a bismaleimide oligomer, a cellulose derivative and an aliphatic urethane acrylate.

8. The method according to claim 7, wherein the saccharide is a disaccharide.

9. The method according to claim 7, wherein the saccharide is selected from maltose monohydrate, sucrose, sucrose octanoate, sucrose octaacetate, dextrin, xylitol and sucrose benzoate.

10. The method according to claim 7, wherein the solid polar compound is present in an amount of from 10 wt % to 60 wt % of the solids of the transparent electrostatic ink composition.

11. The method according to claim 1, wherein the transparent electrostatic ink ink and/or the coloured electrostatic ink comprises a charge director and/or a charge adjuvant.

12. The method according to claim 1, wherein the transparent electrostatic ink and/or the coloured electrostatic ink comprises a resin comprising a co-polymer of ethylene and methacrylic acid and/or a co-polymer of ethylene and acrylic acid.

13. A electrostatic printing system, wherein the system comprises a photoimaging plate and an intermediate transfer member, and the system is to carry out a method comprising:
a. electrostatically printing a discontinuous layer of a transparent electrostatic ink in a first area on a print substrate;
b. electrostatically printing an image comprising a coloured electrostatic ink on the print substrate in a second area, which may or may not be in the same location as the first area,
wherein the electrostatic printing in steps a and b involves, respectively, transferring the transparent electrostatic ink or the coloured ink from the photoimaging plate to the print substrate via the intermediate transfer member;
c. repeating steps a and b on the same or different print substrates, wherein each repeat of step b results in the same or a different printed image, and the discontinuous layer of transparent electrostatic ink varies between at least two different printing patterns.

14. The electrostatic printing system according to claim 13, wherein system is programmed such that the two different printing patterns are different in the shapes and/or locations of the image printed with the transparent electrostatic ink

15. The electrostatic printing system according to claim 13, wherein the system is programmed such that over a plurality of repeats of steps a and b, substantially all of the intermediate transfer member that contacts the print substrate has come into contact with one of, or both of, the transparent electrostatic ink and the coloured electrostatic ink.
